(19) United States
(12) Patent Application Publication
(10) Pub. No.: US 2017/0280629 A1
(43) Pub. Date: Oct. 5, 2017

(54) Methods of Producing Ganoderma Lucidum Mycelia Having Enhanced Ganodermanondiol Content

(71) Applicant: Ami Cosmetic Co., Ltd., Seoul (KR)

(72) Inventors: Kyung-Rok Lee, Seoul (KR); Jung-Il Kang, Jeju-si (KR); Jeong-Hwan Kim, Jeju-si (KR); Hyun-Jung Lee, Jeju-si (KR); Ji-Mi Kang, Jeju-si (KR)

(21) Appl. No.: 15/411,169

(22) Filed: Jan. 20, 2017

(30) Foreign Application Priority Data
Apr. 1, 2016 (KR) 10-2016-0039888

(51) Int. Cl. A01G 1/04; A01G 7/00

(52) U.S. Cl. CPC A01G 1/04; A01G 7/00

(57) ABSTRACT

Provided is a method of culturing ganoderma lucidum mycelia in which the content of ganodermanondiol serving as an inhibitor to melanin biosynthesis is enhanced to improve skin whitening function.

### CROSS-REFERENCE TO RELATED APPLICATION

This application is based on and claims priority from Korean Patent Application No. 10-2016-0039888 filed on Apr. 1, 2016 in the Korean Intellectual Property Office, the disclosure of which is incorporated herein in its entirety by reference.

### TECHNICAL FIELD

The present invention relates to a culture medium of ganoderma lucidum mycelia and a method of culturing ganoderma lucidum mycelia for enhancing ganodermanondiol content. More particularly, the present invention relates to a method of culturing mycelia, in which ganoderma lucidum mycelia are cultured to enhance ganodermanondiol content contained in the ganoderma lucidum mycelia by adding an oriental raisin tree extract to the culture medium of ganoderma lucidum mycelia.

### BACKGROUND

Due to environment contamination, exposure of a skin to ultraviolet light is increasing. This causes the pigmentation of the skin to deteriorate as one ages (J. M. Wood, et al. Exp. Dermatol. 8. 153-164 (1999), Kim C. H, et al, J. Kor. acupuncture, 5, 69-78 (2004)). Skin coloring has received much attention in terms of cosmetic purpose and studies to discover more stable and effective skin whitening materials are conducting (Hwang J. S. et al. J. Soc. Cosmet. Sic. Kor. 28(1), 135-149(2002)). Tyrosine, a kind of amino acid, is oxidized by tyrosinase to form dopa, which will become dopaquinone after hydrogen is removed. In turn, the dopaquinone is reorganized in a form of 5,6-quinone indole which polymer can eventually synthesize a melanin polymer by polymerization (Ken-ichi. Y, et al. J. Proteome Research. 2(1). 69-7(2002)). Various studies have been conducted for materials to inhibit tyrosinase reaction to eventually prevent melanin synthesis (e.g., arbutin, kojic acid, glycyrrhiza extracts, or paper mulberry extracts) or materials that can efficiently remove stratum corneum (e.g., AHA, BHA, amino acid, or salicylic acid). Studies on other materials, such as materials for blocking ultraviolet light (e.g., titanium dioxide, gammaoryzanol, or oxybenzone), materials for expressing toxicity to melanocytes to decrease the activity of melanocytes where melanin is synthesized (e.g., vitamin C), or for removing active oxygen (e.g., vitamin E or vitamin C), have also been conducted (K. T. Lee, et al. J. Cosmet. Sic., 54, 133 (2003), K Sato, et al. Biol. Pharm. Bull., 31, 33 (2008), Battaini, G., et al, J. Biol. Inorg. Chem. 5, 262-268 (2000)). However, those materials have a limited effect or are unstable in the volume necessary for an effective dosage, making them of limited use in efforts to keep the skin safe. Also, substantial reliance of imported ingredients for these materials demands studies to develop more stable and effective substances inhibiting melanin synthesis (Lee. H. B et al. J. Kor. Soc. Food Sci. Nutr. 34(9), 1325-1329 (2005)). Accordingly, studies on functional whitening materials utilizing extracts of various natural products as an alternative material for skin whitening have been conducted, and mori radicis cortex, the extract of trichosanthes kirilowii, chestnut shell, or mung beans have been used as skin whitening materials. In other words, it is urgent to develop superior whitening materials that can replace conventional ones (Park, S. S. et al. J. Life Sci. 17, 816-821 (2007)).

Korean Patent Publication No. 10-2010-0130109, entitled ‘Cosmetic composition containing cultivating mushrooms for skin whitening,’ discloses a cosmetic composition for skin whitening including mycelial extracts of an edible mushroom selected from the group consisting of a king oyster mushroom, an enoki mushroom and a beech mushroom, or a combination thereof. Another Korean Patent Publication No. 10-2005-0034833, entitled ‘The skin lightening cosmetic composition containing extract of Inonotus Obliquus,’ discloses skin lightening cosmetic substances containing extracts of Inonotus Obliquus, in which a fruit body of Inonotus Obliquus and mycelia thereof, water, and any solvent out of hydrophilic solvents and a mixture thereof are mixed together so as to obtain extracts of a fruit body of Inonotus Obliquus and mycelia thereof, and in turn 0.01 to 10 wt % of the extracts are added to the skin lightening cosmetic substances. Specifically, Korean Patent Publication No. 10-2013-0050751 entitled ‘Novel compound from Ganoderma lucidum and use of the same,’ discloses a cosmetic composition for skin whitening including ganodermanondiol extracted from a fruit body of ganoderma lucidum. The ganodermanondiol is an inhibitory material against melanin biosynthesis and tyrosinase activation.

However, the amount of ganodermanondiol that can be obtained from ganoderma lucidum is substantially smaller than that obtained from fruit bodies of mushrooms, thereby making it economically infeasible. In particular, the production of ganodermanondiol utilizing ganoderma lucidum mycelia has rarely been reported.

Therefore, the present invention provides a method of culturing ganoderma lucidum mycelia such a way as to enhance the content of ganodermanondiol that is an inhibitor to melanin biosynthesis and is contained in the ganoderma lucidum mycelia, thereby improving skin whitening function.

### DISCLOSURE

### Technical Problems

The present invention provides a method of culturing ganoderma lucidum mycelia in which skin whitening function is improved by enhancing the content of ganodermanondiol that is an inhibitor to melanin biosynthesis.

### Technical Solution

The present invention provides a culture medium of ganoderma lucidum mycelia including oriental raisin tree extracts.

The present invention also provides a method of culturing ganoderma lucidum mycelia comprising inoculating ganoderma lucidum mycelia to a culture medium of ganoderma lucidum mycelia including oriental raisin tree extracts; and culturing to enhance ganodermanondiol content contained in the ganoderma lucidum mycelia.

The ganodermanondiol serves as an inhibitor to melanin biosynthesis.

### Advantageous Effect

Is Although a limited amount of ganodermanondiol was included in the ganoderma lucidum mycelia, it may be possible to increase a yield of ganodennanondiol according to an embodiment of the present invention. Since the ganodermanondiol serves as an inhibitor of the melanin biosynthesis, the increase in the yield of ganodermanondiol can make a contribution to the development of an industry related to skin whitening cosmetic products.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together description, serve to explain principles of the present invention. In the drawings:

FIG. 1 is a graph illustrating an increase of ganodermanondiol content contained in ganoderma lucidum mycelia according to a concentration of oriental raisin tree extract added therein;

FIG. 2 is a graph illustrating cytotoxicity of ganoderma lucidum mycelial extract according to a concentration of oriental raisin tree extract added therein; and

FIG. 3 is a graph illustrating inhibitory activity of ganoderma lucidum mycelial extract to melanin biosynthesis according to a concentration of oriental raisin tree extract added therein.

### DETAILED DESCRIPTION OF THE DISCLOSURE

Hereinafter, the present invention will be described in more details with reference to accompanying embodiments. It is noted, however, that the scope of the present invention should not be construed as limited to the embodiments set forth herein. Rather, these embodiments are provided so that this disclosure will be illustrative and exemplary.

### EXAMPLE 1.

### Producing ganoderma lucidum mycelia

Ganoderma lucidum No. 2 bought from Mushroom Department of National Institute of Horticultural and Herbal Science, Rural Development Administration, was used as the ganoderma lucidum mycelia. The Ganoderma lucidum No. 2 was aseptically separated and cultured in a PDA culture medium (containing 15 g of agar, 4 g of potato extract, and 20 g of glucose per 1 L culture solution).

### EXAMPLE 2.

### Producing Oriental Raisin Tree Extract

A 35 g of oriental raisin tree was ground and added with 350 g of purified water to conduct hot water extraction, which was repeated twice. The filtered extracts were obtained and used as an oriental raisin tree extract (100%).

### EXAMPLE 3.

### Culture Condition and Producing a Culture Medium for Liquid Culture

In order to produce a culture medium for liquid culture to enhance ganodermanondiol content of ganoderma lucidum mycelia, 100 ml of PDB culture medium (containing 4 g of potato extract and 20 g of glucose per 1 L of culture solution) and the oriental raisin tree extract (100%) prepared in Example 2 are mixed in a 250-ml triangular flask to make concentrations of 1, 5, 10 and 15 respectively. Then, the ganoderma lucidum mycelia obtained in Example 1 are ascetically sliced in a short size and placed in the 250-ml triangular flask to perform shaking culture at 100 revolution per minute (rpm) for 5 days.

### EXAMPLE 4.

### Producing ganoderma lucidum mycelia Extracts

The cultured ganoderma lucidum mycelia are separated from the culture medium and dried with hot air. Next, 0.2 g of the dried specimen is added with 50 ml of 70% ethanol to conduct reflux extraction, which is repeated twice, and filtered extraction liquid can be obtained. The extraction liquid may be concentrated in a reduced pressure to obtain 50 mg of ganoderma lucidum mycelia.

### EXAMPLE 5.

### Content Analysis of ganodermanondiol in ganoderma lucidum mycelia

Quantitative analysis of ganodermanondiol was performed using a HPLC (SPD-20A UV/VIS Deteor, LC-20AT Pumping System, Manual Injection Value 20 μl Loop, Shimadzu Corp., Japan) equipped with Phenomenex Luna C18UV(2) column (4.6×250 mm, 5 μm, USA). A moving phase thereof was measured with acetonitrile and 0.2% acetic acid, while setting flow rate at 0.8 ml/min, using an ultraviolet detector at 245 nm.

In addition, the quantitative analysis of ganodermanondiol contained in the ganoderma lucidum mycelia was also performed using ganodermanondiol (99% purity) purchased from ChemFace® (China) as a standard material.

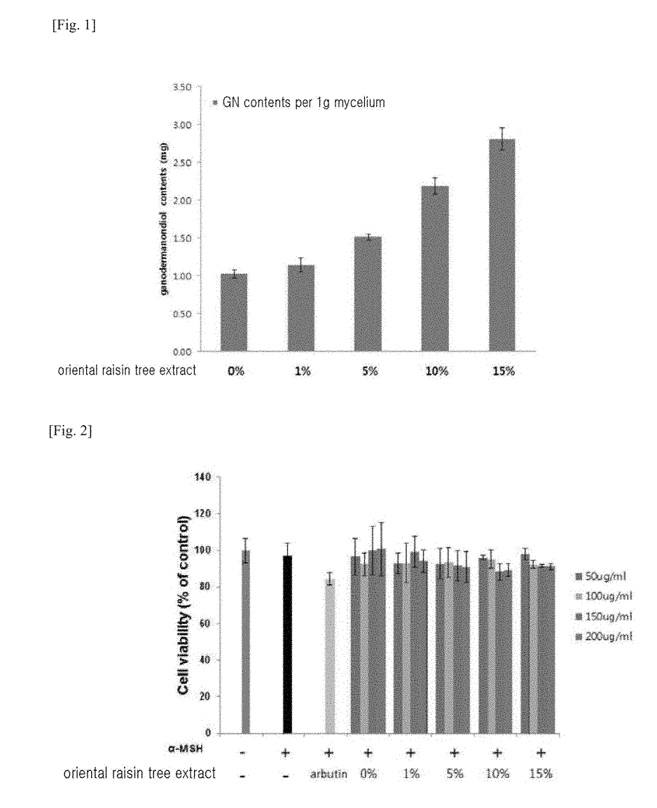

The content of ganodermanondiol in the ganoderma lucidum mycelia according to a concentration of oriental raisin tree extract added in the ganoderma lucidum culture medium was analyzed and the results thereof are illustrated in FIG. 1 and. TABLE 1 below.

TABLE 1

| | Concentration of oriental | Ganodermanondiol |
|---|---|---|
| Specimen | raisin tree extract (%) | contents (mg/g) |
| Ganoderma | 0 | 1.02 ± 0.05 |
| lucidum | 1 | 1.14 ± 0.09 |
| mycelia | 5 | 1.51 ± 0.04 |
| | 10 | 2.19 ± 0.11 |
| | 15 | 2.81 ± 0.15 |

The ganodermanondiol content of the ganoderma lucidum mycelia according to a concentration of oriental raisin tree extract is described in TABLE 1. As shown in TABLE 1 and FIG. 1, the ganodermanondiol content of the ganoderma lucidum mycelia increases as the concentrations of the oriental raisin tree extract increases.

### EXAMPLE 6.

### Effect on Cell Survival of Melanoma B16F10 Cell Line

A melanoma B16F10 cell line purchased from American Type Culture Collection (ATCC, 6475) was used. The cell line was cultured in 5% of CO₂ culture medium at a temperature of 37□ using Dulbecco's Modified Eagle Medium (DMEM) containing 10% of Fetal Bovine Serum (FBS). All cells during experiments were experimented at 80 to 90% of confluency.

MT assay was performed to confirm whether ganoderma lucidum mycelial extracts and the oriental raisin tree extract have cytotoxicity on melanoma B16F10 cells or not. A 100 μl of DMEM containing 10% of FBS is dispensed in a 96-well plate such that approximately 3×10³ of cells can be placed in each well, which is then cultured under the condition of 5% of CO₂ for 24 hours. Then, the culture medium was removed and the extracts having different concentrations were processed such that each group was triplicated and cultured under the condition of 5% of CO₂ at 37° C. for 72 hours.

After culturing, 10 μl of 5-mg/ml MTT reagent was dispensed in each well of the culture medium including the experiment solution and the 96-well plate was cultured for 3 hours without light. The culture medium including the MTT reagent was then removed and 100 μl of DMSO was added to dissolve formazan crystal, which is followed by measuring 570 nm absorbance to determine the cell survival rate.

Cell Survival Rate (%)=(Absorbance of Control Group/Absorbance of Experimental Group)×100

As shown in FIG. 2, the ganoderma lucidum mycelial extract and mycelial extract added and cultured with oriental raisin tree extracts according to an embodiment of the present invention did not show cytotoxicity to melanoma B161-10 cells in a concentration range of 50 to 200 μg/ml.

### EXAMPLE 7.

### Inhibitory Effect of Melanoma B16F 10 Cell Line on Melanin Synthesis

Melanoma B16F10 cells are dispensed in a 6-well plate to become a concentration of 1×10⁵ cells/well using DMEM containing 10% of FBS and cultured under the condition of 5% of CO₂ at 37□ for 24 hours. Next, the culture medium is removed, and ganoderma lucidum extracts and the compound having different concentrations are placed in DMEM culture solution containing 10% of FBS, which is followed by adding α-MSH (100 nM) as an induction agent thereto and cultured under the condition of 5% of CO₂ at 37□ for 72 hours.

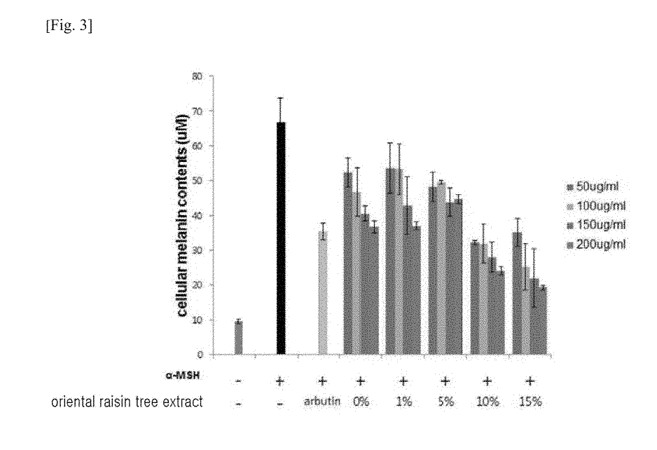

The culture medium is removed therefrom after culturing and it is rinsed with PBS twice, which is followed by dispensing 1 ml of PBS in each well to recover a cell pellet. The recovered pellet is centrifuged at 14,000 rpm for 20 minutes and its supernatant faction is removed. Next, the cell pellet is dried at 60□ for 1 hour and processed in a constant temperature bath of 60□ to dissolve melanin within cells, while adding 150 μl of 1 M NaOH containing 10% of DMSO. Then, 100 μl of the solution is dispensed in a 96-well plate and absorbance at 405 nm is measured using an ELISA reader. The result is compared with a standard curve obtained by using melanin standard solution to quantify the melanin content (FIG. 3).

Inhibition Rate of Melanin Content (%)=1−(Melanin Content of Control Group/Melanin Content of Experimental Group)×100

TABLE 2

| | Concentration | Inhibition Rate |
|---|---|---|
| Specimen | (μg/ml) | (%) |
| No treatment | 0 | 0 |
| Ganoderma | 50 | 21.77 |
| lucidum | 100 | 30.13 |
| mycelium | 150 | 39.37 |
| | 200 | 45.09 |
| Mycelium added | 50 | 27.93 |
| with oriental | 100 | 25.95 |
| raisin tree | 150 | 34.53 |
| extract 5% | 200 | 33.21 |
| Mycelium added | 50 | 47.51 |
| oriental | 100 | 62.25 |
| raisin tree | 150 | 67.09 |
| extract 15% | 200 | 71.27 |
| Albutin | 500 | 47.07 |
| Mycelium added | 50 | 19.78 |
| oriental | 100 | 20.23 |
| raisin tree | 150 | 35.85 |
| extract 1% | 200 | 44.65 |
| Mycelium added | 50 | 51.91 |
| oriental | 100 | 52.35 |
| raisin tree | 150 | 58.07 |
| extract 10% | 200 | 64.01 |

Inhibitory effect of melanin content in the melanoma B16F10 cells is described in TABLE 2.

As shown in FIG. 3, ganoderma lucidum mycelial extract plays a significant role in inhibiting the melanin content produced by the α-MSH induction, depending on concentration, as the concentration of the oriental raisin tree extract added therein increases (TABLE 2).

What is claimed is:

1. A culture medium of ganoderma lucidum mycelia including oriental raisin tree extract to enhance ganodermanondiol content contained in ganoderma lucidum mycelia.

2. A method of producing ganoderma lucidum mycelia in which ganodermanondiol content is enhanced by adding oriental raisin tree extract.
